(19) United States
(12) Patent Application Publication
(10) Pub. No.: US 2008/0205081 A1
(43) Pub. Date: Aug. 28, 2008

(54) Luminaire with Stack of Flat Panel Light Guides

(75) Inventors: Willem Lubertus Ijzerman, Eindhoven (NL); Ramon Pascal Van Gorkom, Eindhoven (NL); Anthonie Hendrik Bergman, Eindhoven (NL); Michel Conelis Josephus Marie Vissenberg, Eindhoven (NL); Denis Joseph Carel Van Oers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,340

(22) PCT Filed: Sep. 18, 2006
(86) PCT No.: PCT/IB06/53338

§ 371 Date: Mar. 19, 2008

(30) Foreign Application Priority Data
Sep. 19, 2005 (EP) 05108581.9
Mar. 31, 2006 (EP) 06112057.2

(51) Int. Cl. F21V 8/00

(52) U.S. Cl. 362/616

(57) ABSTRACT

A luminaire comprising a transparent light guiding structure (2), including a stack of transparent, flat panel light guides (3). Each panel light guide has an in-coupling edge (4) adapted to receive light from said light source and couple this light into the light guide, and at least one out-coupling surface (10, 10a) adapted to couple light out of the light guide, wherein the out-coupling surfaces being distributed along a plane of extension of said light guiding structure. The stacked light guiding structure according to the present invention is easy to manufacture even for large sizes, and consists principally of existing elements (flat panel light guides). Also, an improved transparency can be achieved with this design.

The present invention relates to luminaries comprising a light guide adapted to receive light form at least one light source.

A flat light guide of a transparent material (e.g. glass or PMMA) can be used to create a flat, transparent luminaire, i.e. a light source for illuminating purposes, primarily indoors. This is well known, and commonly applied in LCD back and front lights. Light from CCFL, HCFL or LED is coupled into the light guide. Optical out-coupling structures such as wedges or a suitable coating can be arranged on the surface of the light guide to remove the conditions for total internal reflection, thus coupling light out of the light guide.

A problem related to such luminaires is achieving a uniform distribution of light coupled out of the light guide. The structures (or coatings) that are arranged closest to the light source tend to couple out most of the light, while structures that are further away from the light source tend to couple out less light. This problem can be mediated by a proper distribution of the structures

However, this results in a trade off between light efficiency and transparency. In order to couple out a sufficient amount of light in some areas of the light guide, a large number of out-coupling structures are required. However, this makes the luminaires non-transparent.

In the field of automotive lighting devices, such as taillights and turning indicators, similar problems have been encountered. One solution has been proposed in US 2003/0235046, which discloses an injection molded light guiding body of a plastic material. The light guiding body is adapted to couple in light in one end, and couple out light at a plurality of ledges having surfaces forming an angle with the plane of the body. The ledges are essentially equidistant to each other, securing a uniform distribution of out-coupled light. The light guiding bodies can be circular discs, with the light sources arranged around the perimeter of the body.

While suitable as lighting devices in vehicles, the injection molded plastic bodies can not be manufactured in sizes suitable for luminaries. Further, it is difficult to make such plastic bodies transparent.

It is therefore an object of the present invention to provide an improved transparent luminaire, allowing a uniform distribution of out-coupled light.

According to a first aspect of the present invention, this and other objects are achieved with a luminaire comprising an essentially transparent light guiding structure adapted to receive light from at least one light source. The light guiding structure comprises a stack of transparent, flat panel light guides, each panel light guide having an in-coupling edge adapted to receive light from said light source and couple this light into the light guide, and at least one out-coupling surface adapted to couple light out of said light guide. The out-coupling surfaces are distributed, preferably uniformly, along a plane of extension of the light guiding structure so as to promote the transparency of said light guiding structure.

The expression “essentially transparent” is used to indicate that the out-coupling surfaces may in fact be locally non-transparent. As mentioned, this is a problem in the prior art, where the out-coupling surfaces need to be densely arranged in areas far from the light source in order to provide a uniform distribution of light, resulting in reduced transparency. According to the present invention, thanks to the multi-layer light guide, the out-coupling surfaces can be sufficiently distributed so as to ensure a transparent impression of the light guiding structure.

Compared to the injection molded body disclosed in US 2003/0235046, the stacked light guiding structure according to the present invention is easy to manufacture even for large sizes, and consists principally of existing elements (flat panel light guides). Also, an improved transparency can be achieved with this design compared to the design in US 2003/0235046.

Further, the distribution of light can be controlled more efficiently compared to the light guide in US 2003/0235046, as light coupled into one particular panel light guide will be coupled out at the out-coupling surfaces of this panel.

By using a stack of thin light guides compared to using one light guide the light source will also be reflected more times before leaving the light guide. This improves the mixing of light, which is advantageous, in particular in the case of a multi color light source (e.g. a plurality of different colored LEDs).

An additional advantage is that collimation is preserved. The angular spread that is coupled in the light guide at the entrance side is the same as the angular spread that leaves the light guide. So, no additional scattering or oblique light is created.

The concept of stacking a plurality of flat light guides is known per se, e.g. for use as backlights in transparent displays. However, such backlights are arranged at the back of the display, and do not need to be transparent. Thus, the out-coupling structures can be arranged in an optimal fashion with respect to achieving a uniform distribution of out-coupled, without concern about reducing transparency. The reason for using a multi layer light guide is typically instead related to providing various types of light from the backlight, e.g. light of different polarization, or light of different color. Such prior art light guides would not be contemplated to solve transparency problems present in the field of luminaries.

The panel light guides can have different sizes and be arranged so that in-coupling edges of all panel light guides are aligned essentially adjacent to each other. Each panel light guide can then have an edge opposite the in-coupling edge that is adapted to form one of said out-coupling surfaces. This results in a stacked light guiding structure that receives light in one end and out-couples it from the edges opposite this end. As the panel light guides have different size, these opposite edges will be distributed along the length of the structure. Preferably, the sizes are chosen so that the opposite edges will be uniformly distributed along the length of the structure.

By out-coupling all light at the opposite edges, the light guiding structure becomes light efficient. All light is coupled out at the end of each light guide, and there is no recycling or out-coupling of light under oblique angles.

The panel light guides are preferably equal in shape, e.g. rectangular or circular. This facilitates manufacturing even further, both in terms of making the individual panel light guides and in terms of assembling the stacked light guiding structure.

The panels are further preferably be stacked in order of size, i.e. from the largest to the smallest, so that each panel light guide has a free portion that has one side that is uncovered by other panel light guides in the stack. This results in a rough wedge shape, where the opposite edges form terraces on the wedge slope.

The out-coupling surfaces in the free portion of each panel light guide can be adapted to couple light out on the uncovered side. By out-coupling the light on this side, there will be less interfaces at which Fresnel losses occur for light that passes through the stack of plates.

The opposite edges can be essentially straight across the width of the light guide and aligned in parallel, or they can be curved and aligned equidistantly. Such a design will enable uniform distribution of light out-coupled from these opposite edges.

The out-coupling of light can be ensured in various ways. For example, each out-coupling edge can form such an angle with a plane of extension of the planar light guide that light coupled into the light guide is directed out of the light guide by reflection in the out-coupling edge. This effect can be enhanced by applying a reflective surface on the out-coupling edge. Other out-coupling structures can also be employed, in order to ensure that light is coupled out along the opposite edge.

According to a further embodiment of the present invention, the light guiding structure is adapted to receive light form at least two light sources. These light sources may for example be arranged on either side of the light guiding structure.

The panel light guides of the structure can then include a first set of light guides adapted to receive light from a first light source, and a second set of light guides adapted to receive light from a second light source.

Alternatively, at least one panel light guide can have two in-coupling edges, each arranged to receive light from one of the light sources. Such a panel light guide will thus extend between the two light sources, and have its out-coupling surfaces distributed there along.

The out-coupling surfaces can further comprise intermediate out-coupling surfaces, positioned between the in-coupling edge and the opposite edge. Such intermediate surfaces should have a reflectivity less than one, in order to allow a portion of the light to pass through and be coupled out by the opposite edges of the light guide. These extra out-coupling surfaces serve to reduce the glare of the luminaire because the brightness is spread over a larger region, and can be used to create a uniform out-coupling.

According to a second aspect of the present invention, a composite luminaire comprises two luminaires each having a light source and a light guiding structure with panel light guides of different sizes. The light guiding structures of said luminaries are arranged in a juxtaposed position, so that the out-coupling edges of the first light guiding structure are aligned face-to-face with the out-coupling edges of the second light guiding structure. This results in a light guiding structure formed by two stacks, each preferably wedge shaped to fit with the other.

This and other aspects of the present invention will now be described in more detail, with reference to the appended drawings showing currently preferred embodiments of the invention.

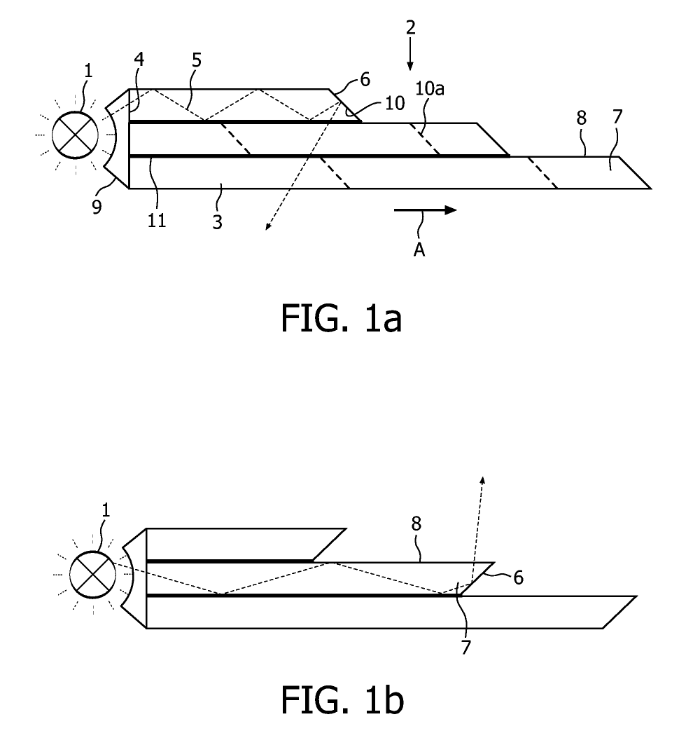

FIG. 1a is a side view of a luminaire according to a first embodiment of the invention.

FIG. 1b is a side view of a variant of the luminaire in FIG. 1a.

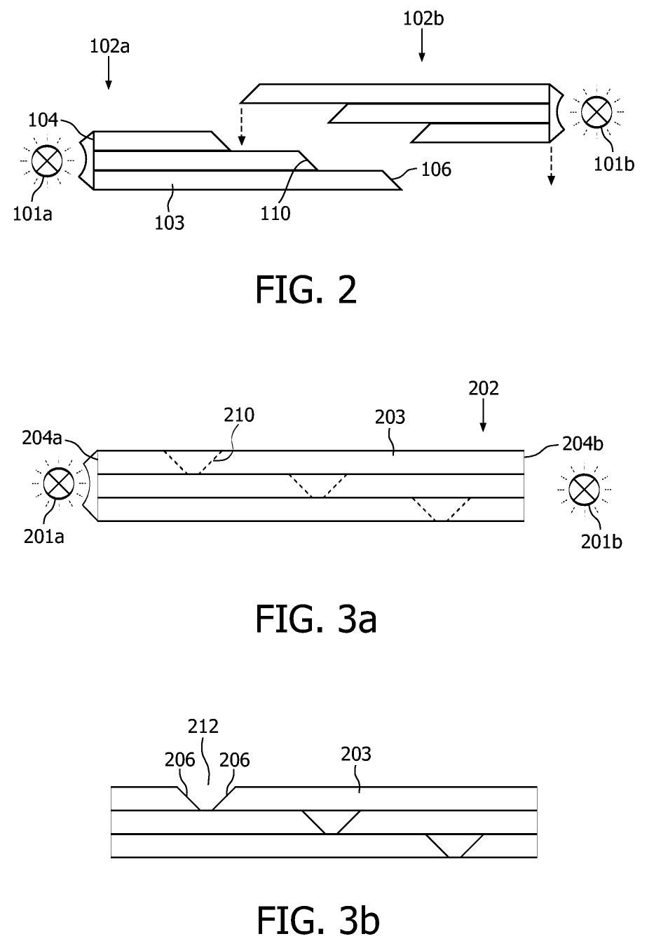

FIG. 2 is a side view of a luminaire according to a second embodiment of the invention.

FIG. 3a is a side view of a luminaire according to a third embodiment of the invention.

FIG. 3b is a side view of a variant of the luminaire in FIG. 3a.

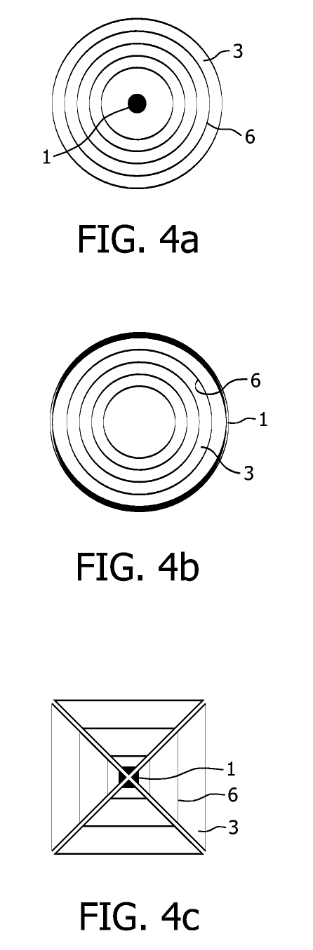

FIGS. 4a-c are examples of possible shapes of luminaires according to the present invention.

FIG. 1a shows a first embodiment, comprising a light source 1 and a stack 2 of differently sized flat panel light guides 3. The light source can be a LED, possibly a colored LED, but can also be combined RGB-LEDs, a CCFL or any other type of suitable light source. Each light guide may be made of a slab of a single dielectric material or combinations of dielectric materials. Suitable dielectric materials include different transparent materials, such as various types of glass, poly-methyl methacrylate (PMMA) etc. The waveguide may also be air, at least partly enclosed by waveguide reflectors. A waveguide comprising a slab of a dielectric material may for its function rely upon total internal reflection (TIR), reflectors or a combination of TIR and reflectors at the edges and/or top and/or bottom surfaces.

Each light guide has one edge 4 arranged to receive and in-couple light 5 form the light source 1, and is provided with an out-coupling surface 10 along its opposite edge 6. Remaining edges of the light guide are adapted to provide total internal reflection of light coupled into the light guide under suitable angles.

The sizes of the panels are chosen so that these out-coupling surfaces 5 are distributed along the plane of extension of the panels, in order to provide a uniform distribution of out-coupled light. In the schematic plane view of FIG. 1a, this is indicated by uniform distribution in the direction A.

In the illustrated embodiment, the panels are further arranged in size order, so that each panel 3 has an end portion 7 that is only covered by an adjacent panel on one side. Thus, this portion has a free side 8, uncovered by other panels.

The light that enters the light guide stack can be pre-collimated by a suitable in-coupling structure 9. For practical applications it is often required that the light that leaves the luminaire has a limited angular extend. Typically the angular spread is limited to +/−30 degrees. If the angular spread of the light in the pre-collimation is limited to say +/−30 degrees (before it enters the light guide), the light that leaves the luminaire has the same angular spread, so the luminaire automatically satisfies this boundary condition.

The light guides can be attached to each other using a suitable adhesive 11. The adhesive can be selected to have an index of refraction so as not to deteriorate transparency of the stack, while at the same time providing an interface between the light guides ensuring total internal reflection conditions for a sufficient range of angels of incidence. Generally speaking, an adhesive having a low index of refraction will be advantageous.

In case the light is pre-collimated, a glue with an index of refraction of approximately 1.4 or lower can be used for attaching the light guides to each other (assuming +/−30 degrees and a light guide with an index of refraction of 1.5). In this case all the plates can be glued together instead of just the plates that are fed by one light source.

In a practical embodiment the stack of light guides needs to be protected against dust and scratches. This can be done by applying a anti-scratch coating on the outer plates or having a transparent box around the light guides (not shown).

According to one example, the opposite edges are shaped to form an angle with respect to the plane of extension of the panel. The angle is selected so as to enable out-coupling of light from the light guide, and is preferably approximately 45 degrees. The edges can be oriented as indicated in FIG. 1a, resulting in light being reflected into the stack. Alternatively, as illustrated in FIG. 1b, the angle of the opposite edges 6 can be adapted to couple out light on the free side 8 of the end portions 7.

The surfaces may additionally be provided with reflection enhancing coatings, e.g. an ESR-foil (3M), a multi-layer reflector, a dielectric or metallic reflector film. By adapting the surfaces to be completely reflective (coefficient of reflectivity equal to 1), all light coupled into the light guide will be out-coupled by the out-coupling surface 10.

Each light guide may additionally be provided with one or more intermediate out-coupling surfaces 10a, between the in-coupling edge 4 and the opposite edge 6. These intermediate out-coupling surfaces 10a can also form an angle with the plane of extension, and have a similar function as the out-coupling surfaces along the opposite edges 6. However, the surfaces 10a must have a reflectivity less than 1, so as to allow a portion of the light to continue along the light guide. The intermediate surfaces 10a can include one of the materials mentioned above, a low index glue, or simply an air gap.

The intermediate surfaces 10a do not necessarily extend across the entire width of the light guide. On the contrary, it may be advantageous to provide the intermediate surfaces along portions of the cross section, in order to ensure that the light guide is formed as one integral piece. If the intermediate surfaces are formed to extend across the entire width of the light guide, the panel light guide may be formed of several pieces, attached to each other along tilted interfaces, and these interfaces will form the integral out-coupling surfaces.

According to a second embodiment of the invention, a luminaire comprises two light sources 101a, 101b and two stacks 102a, 102b as illustrated in FIG. 2. As mentioned above, the light guides 103 in each stack may be attached to each other, and in addition the two stacks 102a, 102b can partly be glued together to form a more rigid structure.

The luminaire in FIG. 2 is basically a combination of two luminaires as shown in FIG. 1. Light is coupled in from both sides, and out-coupled from the respective out-coupling surfaces of each light guide. Preferably, the out-coupling surfaces 110 along the opposite edges 106 of each light guide 103 are adapted to reflect all incident light, so that no light escapes from one light guiding stack into the other.

According to a third embodiment of the invention, shown in FIGS. 3a and 3b, a luminaire comprises two light sources 201a, 201b and one stack 202 of equally sized panel light guides 203. Compared to the luminaire in FIG. 2, the luminaire in FIG. 3 does not include two separate stacks. Instead, each panel light guide 203 in the stack has two sets of out-coupling surfaces 210, forming different angles with respect to the plane of extension of the stack. In the illustrate case, these angles are +/−45 degrees.

In the embodiment illustrated in FIG. 3a, the out-coupling surfaces 210 are formed in the light guides, similar to the intermediate out-coupling surfaces 10a described with reference to FIG. 1. In principle, the out-coupling surfaces 210 can be located similarly as the out-coupling surfaces 110 in the combined stack in FIG. 2, resulting in a stack having similar properties as the combined stack in FIG. 2.

If all the out-coupling surfaces are partially reflective (reflectivity less than 1), a fraction of the light from one light source will pass through all out-coupling surfaces arranged to reflect it downwards. This fraction will then be incident on the back side of out-coupling surfaces adapted to reflect light from the other light source, and a fraction of it will be reflected up-wards. By adapting the number of semi reflective out-coupling surfaces and their reflectivity, the light from the light sources can be divided downwards and upwards in desired proportions.

Alternatively, as illustrated in FIG. 3b, wedge shaped grooves 212 are formed in each panel light guide 203, thus creating two out-coupling edges 206. By forming such grooves in each panel light guide before the successive panel is arranged on top, it is possible to form a stack very similar to the combined stack in FIG. 2, but manufactured in a different way.

The shape of the luminaires in FIGS. 1-3 can be rectangular, with light being in-coupled along one side or along two opposite sides. However, the invention is not restricted to rectangle shaped luminaires. As shown in FIG. 4, various other shapes are possible, with the light source arranged centrally or peripherally. FIG. 4a shows a circular luminaire with a central light source, FIG. 4b shows a circular luminaire with a peripheral light source, and FIG. 4c shows four triangular luminaires with central light sources, arranged to form a rectangular or square luminaire.

The person skilled in the art realizes that the present invention by no means is limited to the preferred embodiments described above. On the contrary, many modifications and variations are possible within the scope of the appended claims. For example, the panel light guides can be arranged in a different order, and various other out-coupling structures may be employed in addition to or instead of the angled edges.

1. A luminaire comprising an essentially transparent light guiding structure (2; 102a, 102b; 202) adapted to receive light from at least one light source, characterized in that
said light guiding structure comprises a stack of transparent, flat panel light guides (3; 103; 203), each panel light guide having an in-coupling edge (4) adapted to receive light from said light source and couple this light into the light guide and at least one out-coupling surface (10, 10a; 110; 210) adapted to couple light out of said light guide,
said out-coupling surfaces being distributed along a plane of extension of said light guiding structure so as to promote the transparency of said light guiding structure.

2. A luminaire according to claim 1, wherein said panel light guides (3; 103; 203) have different sizes and are arranged so that in-coupling edges (4) of all panel light guides are aligned essentially adjacent to each other, and wherein each panel light guide has an edge (6; 106; 206) opposite said in-coupling edge that is adapted to form one of said out-coupling surfaces.

3. A luminaire according to claim 2, wherein said panel light guides (3; 103; 203) have essentially similar shape.

4. A luminaire according to claim 2, wherein said panel light guides are stacked in size order, so that each panel light guide has an end portion (7) that has one side (8) that is uncovered by other panel light guides in the stack (2).

5. A luminaire according to claim 4, wherein out-coupling surfaces in the end portion (7) of each light guide is adapted to couple out light in a direction of said uncovered side (8).

6. A luminaire according to claim 2, wherein said opposite edges (6; 106; 206) are essentially straight and aligned in parallel.

7. A luminaire according to claim 2, wherein said opposite edges (6; 106; 206) are curved and aligned equidistantly.

8. A luminaire according to claim 2, wherein each opposite edge forms such an angle with a plane of extension of the planar light guide that light coupled into the light guide is directed out of the light guide by reflection in said opposite edge.

9. A luminaire according to claim 8, wherein said opposite edge (6; 106; 206) is provided with a reflecting surface.

10. A luminaire according to claim 1, wherein said light guiding structure (102a, 102b, 202) is adapted to receive light form at least two light sources (101a, 101b; 201a, 201b).

11. A luminaire according to claim 10, wherein said light guiding structure includes a first set of light guides (102a) adapted to receive light from a first light source (101a), and a second set of light guides (102b) adapted to receive light from a second light source (101b).

12. A luminaire according to claim 10, wherein at least one panel light guide (202) has two in-coupling edges (204a, 204b), each arranged to receive light from one of said light sources (201a, 201b).

13. A composite luminaire comprising two luminaries according to claim 2, wherein the light guiding structures (102a, 102b) of said luminaries are arranged in a juxtaposed position, so that the out-coupling edges of the first light guiding structure are aligned face-to-face with the out-coupling edges of the second light guiding structure.

14. A luminaire according to claim 1, wherein said out-coupling surfaces comprise intermediate out-coupling surfaces (10a; 210) with a reflectivity less than one.

15. A luminaire according to claim 1, further comprising at least one light source (1) arranged to couple light into said in-coupling edges (4).

16. A luminaire according to claim 1, wherein each panel light guide is adapted to provide total internal reflection conditions for light having an incident angle within a given range.
